(19) United States
(12) Patent Application Publication
(10) Pub. No.: US 2003/0013436 A1
(43) Pub. Date: Jan. 16, 2003

(54) Advertisement offering method and system for wireless display board

(76) Inventor: Jae-Sul Son, Goyang-city, Gyunggi-do (KR)

Correspondence Address: Jonathan Y Kang, Lee & Hong, 221 N Figueroa Street 11th Floor, Los Angeles, CA, 90012-2601, US

(21) Appl. No.: 10/203,165

(22) PCT Filed: Feb. 1, 2001
(86) PCT No.: PCT/KR01/00138

(30) Foreign Application Priority Data
Feb. 12, 2000 (KR) 2000-0006657
May 18, 2000 (KR) 2000-0026714

(51) Int. Cl. H04B 1/38

(52) U.S. Cl. 455/414; 455/566

(57) ABSTRACT

The present invention relates to an advertisement offering method and a system for a wireless display board.

The advertisement offering method for a wireless board includes the steps of: requesting advertisement services from an advertisement information providing section through a network, wirelessly transmitting advertisement information to an output unit which receives the advertisement service from said advertisement information providing section on the basis of said advertisement service request, transmitting advertisement information to said output unit by using an operation input section in the near distance of said output unit, and transmitting at least one of said wireless advertisement information and said near distance advertisement information which are expressed on said output unit to said advertisement information providing section.

### FIELD OF THE INVENTION

The present invention is in the field of a wireless display board system and an advertisement offering method thereof, and is more specifically related to a wireless display board system and a method for offering advertisements or information messages using the same. The wireless display board system displays advertising messages by using various input media and allows data about the advertising messages and related information to be applicable to other uses.

### BACKGROUND OF THE INVENTION

LED (light-emitting diode) display boards have been widely employed for representing messages of guiding or advertising, being disposed at entries of a building, on ceilings of stand rooms, in subways, or in buses in order to take glances of people thereon. There are usually exclusive wires for electrically transferring information messages to the LED boards settled on appointed places so as to display the messages thereon simultaneously in a desired time.

However, since, in the conventional method for controlling a display board system where various input media cannot be supported, informations related to the space around a place where the display board is fixed are excluded, it is hard to provide real or live informations on the spot near the place in which the display board is mounted. Moreover, the conventional control manner uses a unilateral data transmission from an information provider to the display board, making it impossible to accumulate and utilize the information presented on the board, or to control a current status of the board on remote.

To set or to modify the information loaded on the display board, e.g., advertising contents or materials, an advertising hour, or information about a place at which a display board is established, is accomplished by manual operations, causing a procedure of displaying and modifying the information to be complicate and to be in need of a longer time.

### SUMMARY OF THE INVENTION

The present invention is intended to solve the problems. And, it is an object of the invention to provide a wireless display board system and a method for offering advertising services using the system which is adaptable to various input media regardless of a distance therefrom, and capable of offering real information related to a place at which a display board is fixed.

It is another object of the invention to provide a wireless display board system and a method for offering adverting service using the system in which data about an advertising material and advertising information or data about the state of a display board are utilized as reference information in determining a subsequent advertising material, a service fee to be charged and in facilitating the repair work.

It is another object of the invention to provide a wireless display board system and a method for offering advertising services using the system capable of performing an efficient and prompt advertisement, wherein, when data on conditions of an advertisement are input from an advertiser, a proper display board in conformity with those conditions can be automatically found and a proper advertising material in conformity with those conditions is transmitted to the display board.

In order to accomplish those objects, a wireless display board system according to the invention includes an output unit for displaying an information including advertising messages, and an advertising information provider for transmitting the information to the output unit in response to a request for an advertisement service from a user and for receiving the information displayed on the output unit. Further included is a mobile communication site, being connected to both of the advertising information provider and the output unit through a wired communication network and a wireless communication network respectively, for transmitting the information to the output unit from the advertising information provider.

The advertising information provider includes: a web server being accessible with a terminal; a database server for storing information about users, installing places, and wireless display boards; a management server for operating detail information about advertisement makers, advertisers, advertising messages, and service charges; a CRM system for analyzing client information to manage clients and purchase inclination; and a client management server constructed of a UMS to send mails and characters to the clients. Each of the servers is adaptable to SMS, WAP, m_HTM, or IMT-2000.

The output unit includes: a receiver for receiving the information provided from the advertising information provider; a storage unit for storing the information demodulated; a display unit for expressing the information in one of a visual state and an audible state; and an output controller for making the information be expressed on the display unit.

A method for offering advertising information in the aforementioned wireless display board system includes the steps of: requesting an advertisement service to the advertising information provider through a network by a user; transmitting the wireless advertising information to the output unit from the advertising information provider in response to the service requesting; loading nearby advertising information on the output unit by means of an operating device at a place near the output unit; and transmitting one of the wireless advertising information and the nearby advertising information which are displayed on the output unit into the advertising information provider. Further included is the steps of: transmitting a counted data relevant to a displaying time of the advertising information into the advertising information provider through a mobile communication site; and accounting a charge for using the advertising information on the basis of the displaying time.

The step of transmitting the counted data of the displaying time includes the steps of: storing the wireless advertising information and the nearby advertising information in a storage unit; and transmitting the stored advertising information to the advertising information provider through a network.

The step of transmitting the wireless advertising information includes: transmitting the wireless advertising information to a mobile communication site through a wired network; and transmitting the wireless advertising information to the output unit and displaying the wireless advertising information on the output unit.

The step of displaying the wireless advertising information includes the steps of: receiving the wireless advertising information supplied from a server into a receiver of the output unit; and storing the wireless advertising information in a storage unit of the output unit and displaying the wireless advertising information on a display unit of the output unit in accordance with a control operation of an output controller of the output unit.

The step of transmitting the nearby advertising information includes the steps of: receiving an input data supplied by the operating device into a receiver of the output unit; and storing the input data in a storage unit of the output unit and displaying the input data on a display unit of the output unit in accordance with a control operation of an output controller of the output unit.

The step of requesting the advertisement service includes the steps of: writing out an application for requesting the advertising service by a user; storing the application in a database; and checking out a receipt of the application from the advertising information provider.

The method further includes the steps of: analyzing information relevant to advertising contents and running time by a program after constructing a database in which the advertising information from the output unit is stacked; and performing OLAP and data mining process including an accounting for a service charge on the basis of the analyzed information. Still further included is the steps of: inputting information into the database, the input information being relevant to the advertising service and conditions of a place where the output unit is fixed; selecting information corresponding to a user's demand in the database; and transmitting the selected information to the output unit through a wireless communication network and displaying the selected information on the output unit.

The method also includes the step of providing supplemental information to the output unit from a supplemental information provider, the supplemental information provider being connected to the advertising information provider.

### BRIEF DESCRIPTION OF THE DRAWINGS

For a better understanding of the invention, and to show how embodiments of the same may be carried into effect, reference will now be made, by way of example, to the accompanying diagrammatic drawings, in which:

FIG. 1 is a block diagram of a wireless display board system according to an embodiment of the invention;

FIG. 2 is a block diagram of an output unit shown in FIG. 1;

FIG. 3 is a flow chart illustrating a sequence for offering advertising information;

FIG. 4 is a flow chart of interactive operations between a user and a web server when the user requests a service for advertisement;

FIG. 5 is a flow chart for transferring advertising information to a wireless display board from an information provider;

FIG. 6 is a flow chart for providing near-advertising information to the output unit;

FIG. 7 is a flow chart for performing a supplement information transmission service; and

FIG. 8 is a flow chart for transferring information displayed on the output unit into the information provider.

In the figures, like reference numerals denote like or corresponding parts.

### DETAILED DESCRIPTION OF THE PREFERRED EMBODIMENT

Hereinbelow, applicable embodiments of the invention will be described as follows, with reference to the appended drawings.

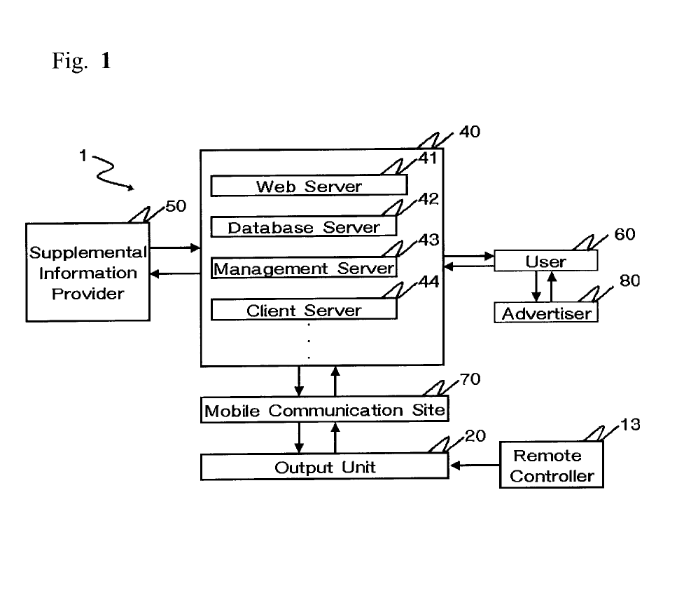

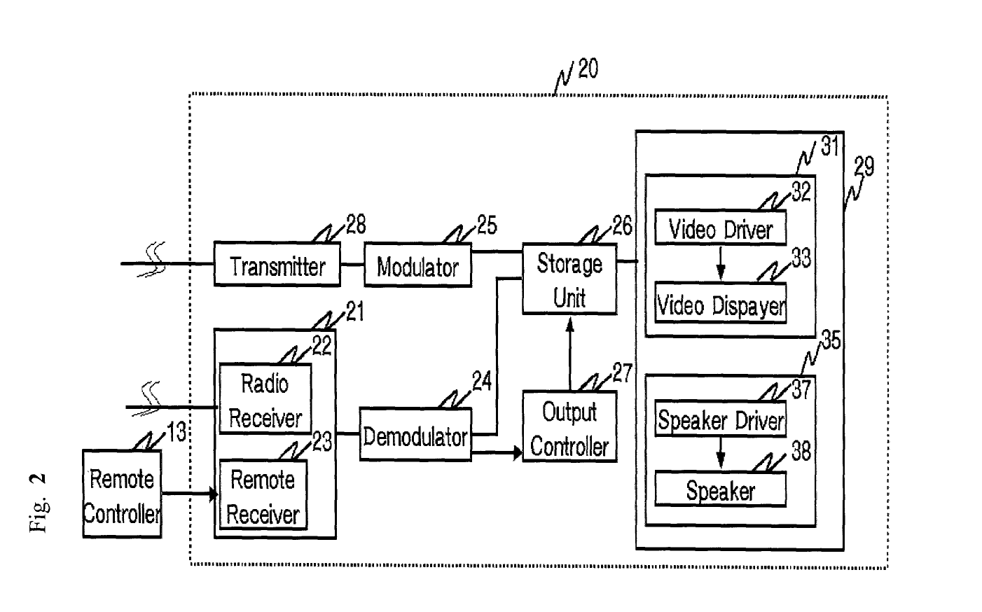

Referring to FIG. 1, a wireless display board system 1 includes output unit 20 displaying advertisement messages and information provided through wired or wireless communication network thereon, advertisement information provider 40 connected to a user 60 through a network. The information provider 40 supplies and receives information to and from the output unit 20. Mobile communication site 70 is interposed between the information provider 40 and the output unit 20, being connected to the information provider 40 through a wired communication network and to the output unit 20 through a wireless communication network, to transfer information from the provider 40 to the output unit 20. The information provider 40 is composed of: web server 41 assisting an access to the system by means of a wired or wireless terminal; data base server 42 storing detail information about users, fixed places, and wireless display boards; management server 43 operating information about advertisers, owners of advertisement business, and accounts; and client server 44 formed of a CRM system analyzing information for clients and purchase inclination, and an UMS sending mails or characters. The servers 41, 42, 43, and 44 are operable in various types of communication protocol such as SMS, WAP, m_HTM, or IMT-2000.

Supplemental information provider 50 is provided for supplying various kinds of additional information about for example sports, weather, stocks, and daily news. The supplement information provider 50 is interfacing with the advertisement information provider 40 in order to transfer the supplemental information into the output unit. In addition, remote controller 13 as an example of an input terminal (or an input medium) is connected to the output unit 20, handling an input operation with characters, identification symbols, and audio information.

Referring to FIG. 2, the output unit 20 has a receiver for receiving the advertisement information supplied through the servers 41˜44 and transferred thereto through a communication network, demodulator 24 for demodulating data signals of the advertising information supplied from the receiver 21, storage unit 26 for storing the information passing through the demodulator 24, and transmitter 28 for sending advertising information passing through modulator 25 after being displayed in the output unit 20. The output unit 20 also employs output controller 27 for controlling the information in the storage unit 26, and display unit 29 for expressing the advertising information or messages thereon.

The display unit 29 is formed of video part 31 and audio part 35. The video part 31 has video displayer 33 made of LED, LCD, PDP, or CRT, and video driver 32 for controlling the video displayer 33. The audio part 35 has speaker 38 and speaker driver 37. The receiver 21 is composed of radio receiver 22 for receiving information supplied from the information provider 40 through a wireless communication network, and remote receiver 23 for receiving information from the remote controller 13.

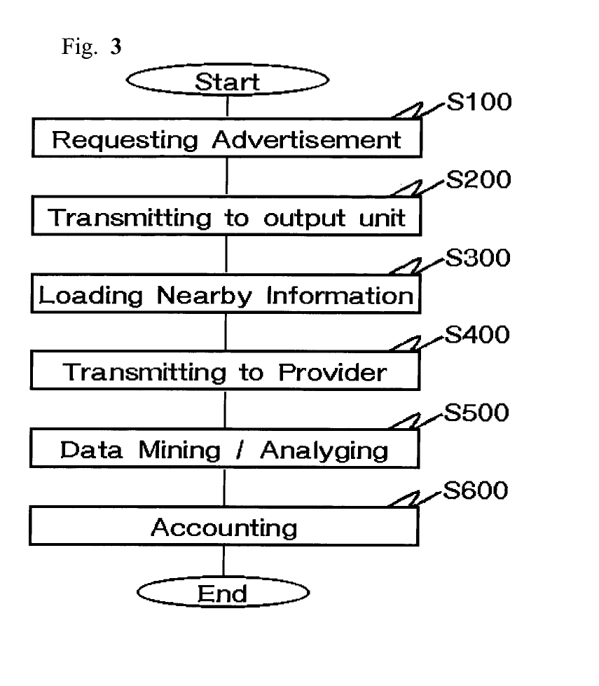

FIG. 3 shows a brief procedure for providing advertising information. The procedure is composed of sequential steps of requesting an advertisement by a user (S100), transferring advertising information to the output unit by a wireless way (S200), loading nearby information on the output unit (S300), transferring the information loaded on the output unit into the information provider (S400), checking and analyzing the displayed information (S500; data mining), and accounting a charge for the advertisement of the information and installment of the system (S600).

In the step S100, the user 60 requests an advertisement from a wireless advertisement service provider through a network. The service including messages, client managements, or advertisements is supplied to the user by way of a wireless communication terminal or a web (i.e., internet) through a computer terminal. In the step S200, the advertising information is transferred to the output unit 20 through a wireless (or radio) communication way. An embodiment of the invention employs the mobile communication site 70 as the transmission manner. The step S300 loads information on the output unit 20 by means of the remote controller 13 at a place near the output unit 20. The information, one of the wireless or the nearby, displayed on the output unit 20 is supplied to the information provider 40 through the mobile communication site 70 at the step S400.

The step S500 includes several sub-steps of analyzing, accounting, and auto-transferring. At the analyzing steps, a database is established with data of the advertising information displayed on the output unit 20, and then an analysis is carried out for data relevant to contents and time of the advertisement with a software program such as OLAP (on-line analytical processing). And then, at the accounting step checks charges including the use of advertisement on the basis of the result from the analyzing step. The auto-transferring step is composed of receiving information about the advertisement and conditions of a place where the output unit is installed, extracting information corresponding to an requirement of the user 60, sending the selected information to the output unit 20. Therefore, it is possible to establish appropriate information associated with conditions to which the user and advertiser agree, and also to account the charges for advertising, installing the wireless display board system, and so forth.

The step S600 includes sub-steps of introducing information about installment conditions and positions, and advertising contents from the advertisers 80 who want to advertise, searching that there are an advertise and an advertisement maker in agreement with the conditions etc. after constructing a database from the introduced information, and auto-transferring an advertisement adaptable to the conditions and accounting an engaged charge for a performance of the advertisement

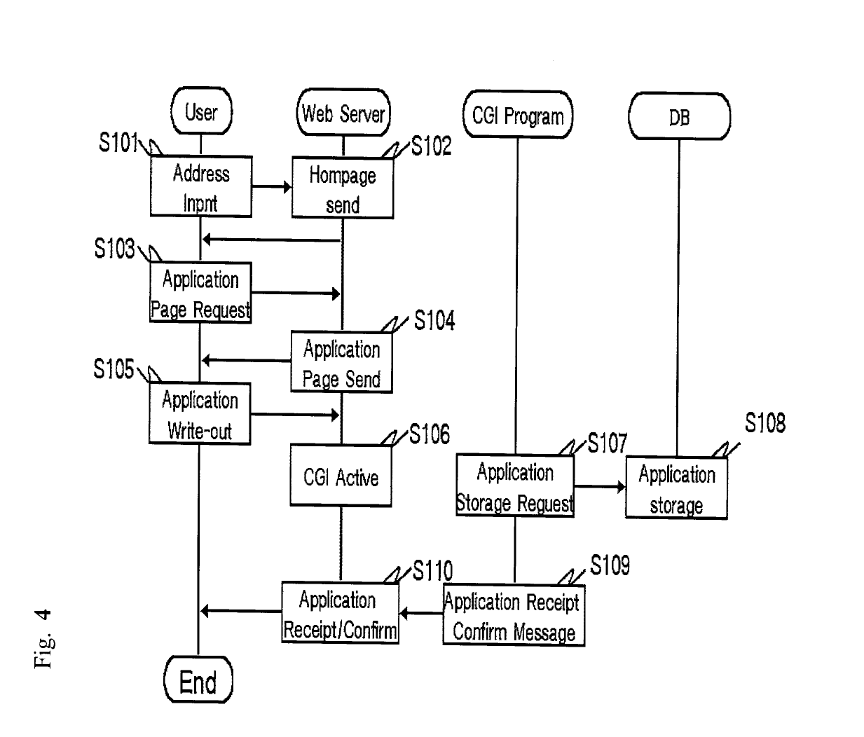

Now an explanation about detail procedures of advertising will be described in conjunction with FIGS. 4 through 8.

FIG. 4 shows a registration progress in the sides of the user and the web server 41 upon a request of an advertisement service from the user 60, corresponding to the step S100. After inputting an address of the web server 41 (S101), a home page for the advertisement service is sent to the web server (S102). If there is a signal requesting an application from the user 60 (S103), the web server 41 transfers the application to the user 60 (S104). After completing a writ-out of the application (S105), a request for storing the application occurs at the web server 41 by activating CGI drive program (S107), and then the application is stored in a user database (S108). And a message of a safe receipt for the application is made out by means of the CGI drive program (S109) and informed to the user 60 (S110). Then, the requesting operation is over.

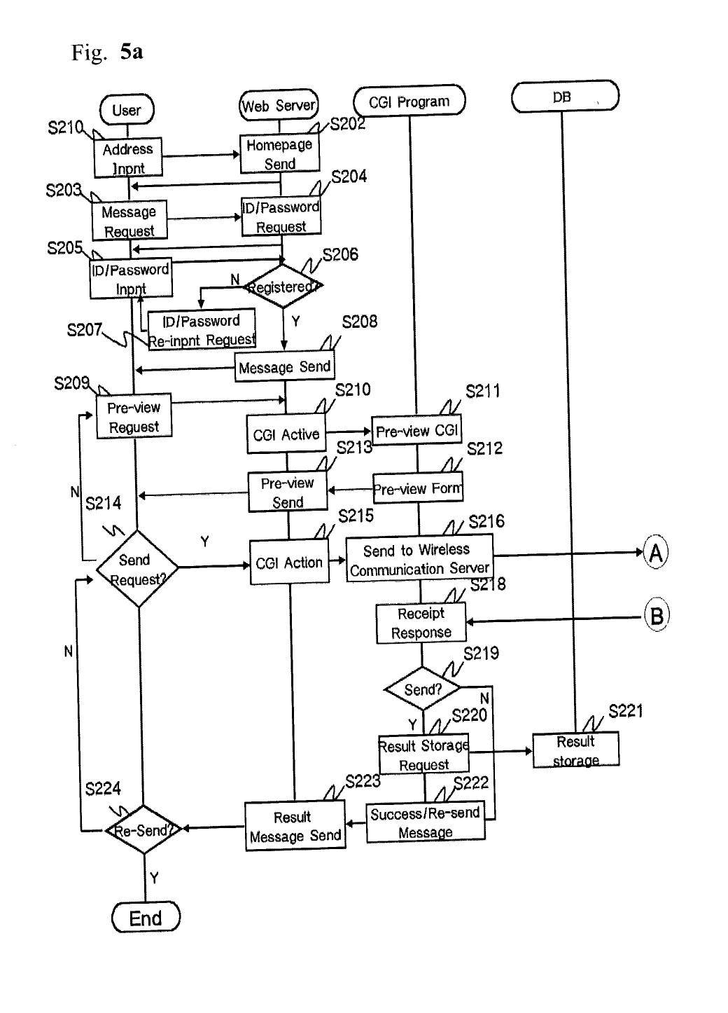

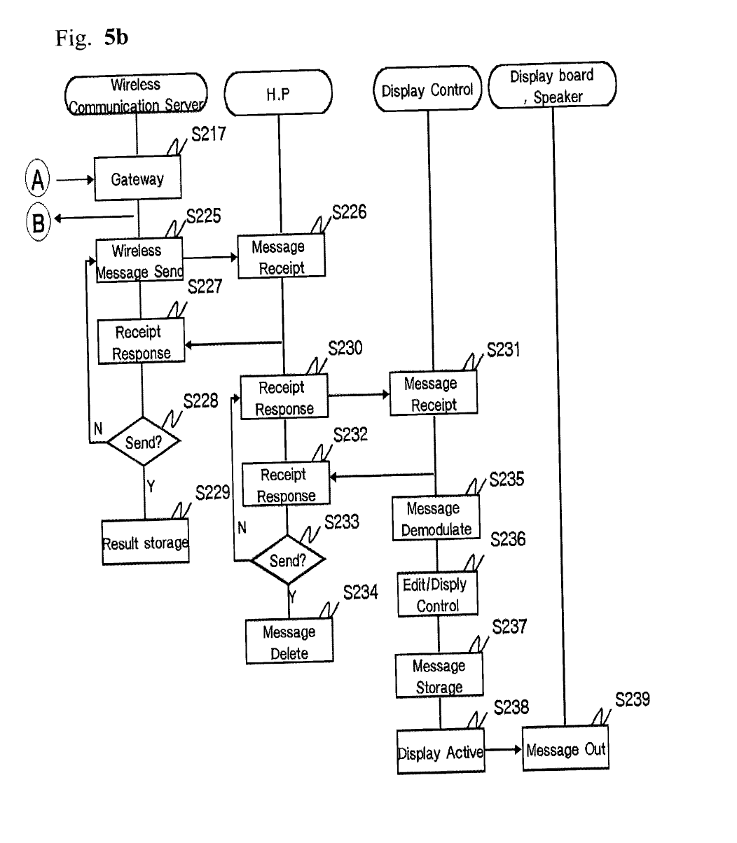

FIG. 5 shows detail process for transferring advertising information from the provider 40 to the output unit 20, corresponding to the step S200. After inputting an address of the web server 41 by the user 60 (S201), the web server 41 transfers a main form of a home page to the user (S202). If there is a request for messages from the user (S203), the web server demands the user to enter his ID (identification) and password (S204). The user's ID and password entered is verified whether those have been registered in the web server (S206). If the ID and password have not been registered in the web server, a re-input for a verified ID or a password is required therefrom (S207). If the ID and password are correct with the registered in the web server, a message informing of successful access is sent to the user (S208).

After making out a pre-view picture by means of a pre-view CGI according to a request for message input options and channel selection pre-view (S209˜S212), the preview picture is transferred to the user (S213) and then transferred to the wireless communication server by activating the CGI program (S215, S216) in response to a presence of a request for sending the pre-view picture from the user (S214). After passing through wire/wireless gateway of the wireless communication server (S217), a transmission result is stored in a database in response to a request for storage when a response for receiving appears from the CGI (S218, S220, S221). If there is no transmission from the wireless communication server, the resultant message according to messages of success and re-transmission is transferred to the user through the web server and detected an occurrence of the re-transmission by the user (S222˜S224).

Meanwhile, after transferring a wireless message to a personal communication terminal (e.g., H.P.) from the wireless communication server (S225), the transmission result is stored in the communication server when there is a response for receipt from the H.P. (S227˜S229). And then the transmitted message is transferred to the output unit 20, and the message is deleted in the H.P. when the transmission to the output unit is completed (responding to an presence of a response for receipt from the output unit) (S230˜S234). After receiving the message from the H.P. (S226), demodulating the message data, editing/controlling the data for displaying, storing the displaying data, and activating the display unit are performed in sequential in order to express the advertising messages on the video part (or a display board) or from the audio part (e.g., a speaker) (S235˜S239).

On the other side, for sending the nearby advertising information to the output unit 20 with using the remote controller 13, wireless (or radio) advertising information transferred to the output unit 20 from the information provider 40 through the mobile communication site 70 is supplied from the servers, and applied into the radio receiver 22 through a wireless communication network. After passing through the demodulator 24, the data is stored in the storage unit 26, and then output in the form of characters, video, motion pictures, or audio through the display unit 29 under the control of the output controller 27.

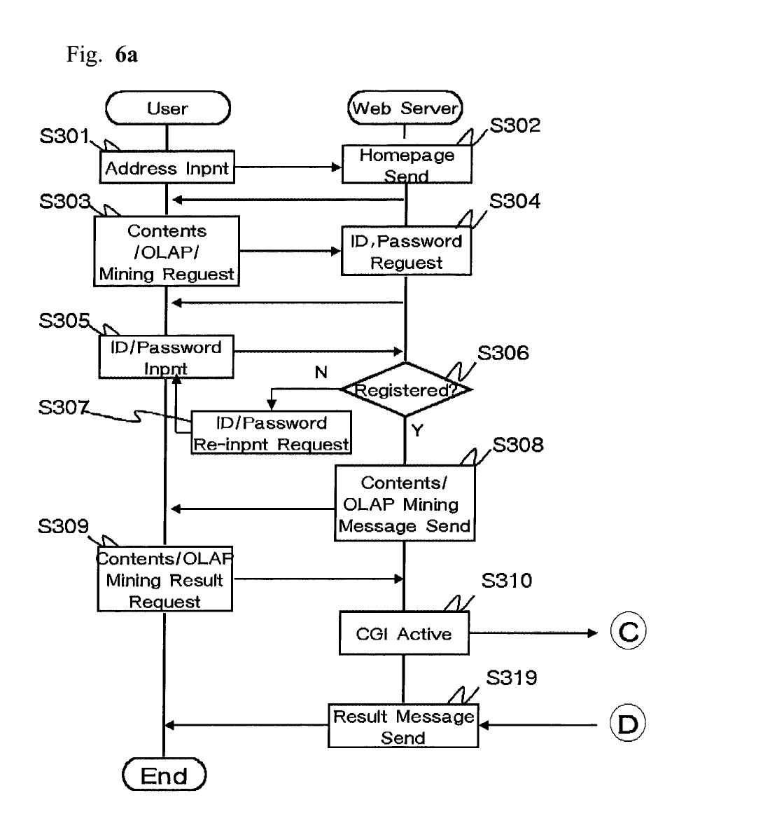

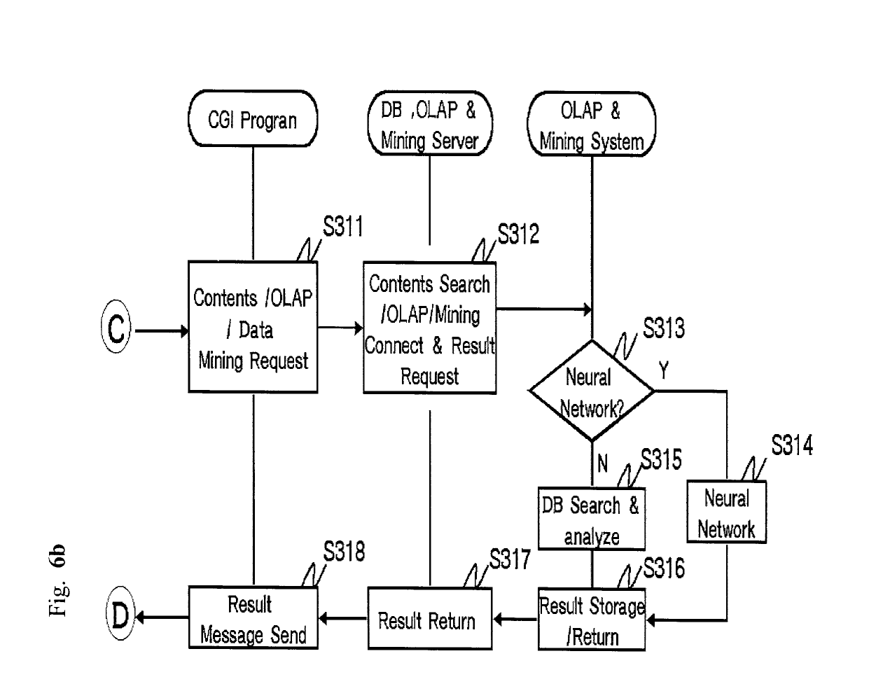

The invention makes it available to construct a large database to analyze information relevant to an advertisement which provides a global service to a place spaced far from or near a information source, by means of an inquiring for message contents, OLAP, and data mining, and to establish a system for performing the OLAP and data mining so as to enhance satisfaction of a service user, as shown in FIG. 6.

Referring to FIG. 6, after inputting an address of the web server, a main form is transferred to a service home page, the user requests message contents, OLAP, and the data mining, and thereby the web server demands an ID and a password to the user (S302˜S304). If an input ID and a password have not been registered in the web server, a re-input for the ID and password is required (S305˜S307). If an input ID and password match with the registered, the message contents, OLAP, and data mining messages are transferred from the web server to the user, and the CGI is activated (S308˜S310). After then, according to requests for connection to servers of message searching, OLAP, and the data mining and for the result thereof (S311, S312), resulting messages are made out by the CGI program and transferred to the user if the connection is through a neural network (S314, S316˜S319). If the connection is not through the neural network, searching and analyzing database are carried out (S315) and next the steps S316˜S319 are performed.

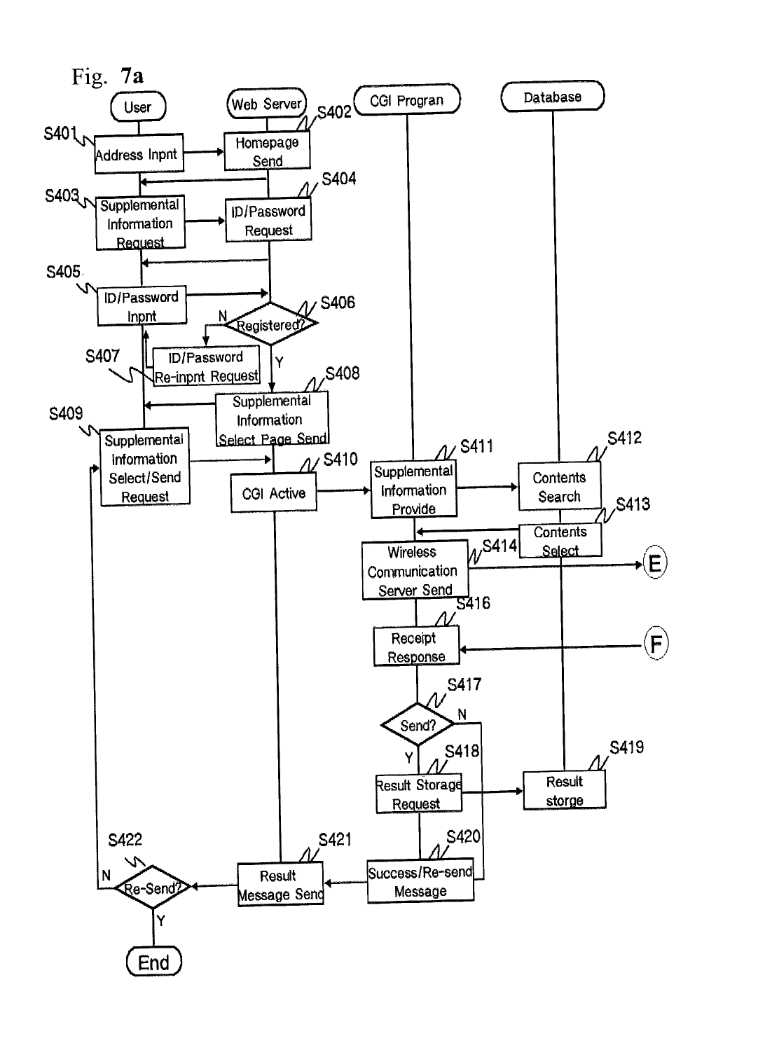

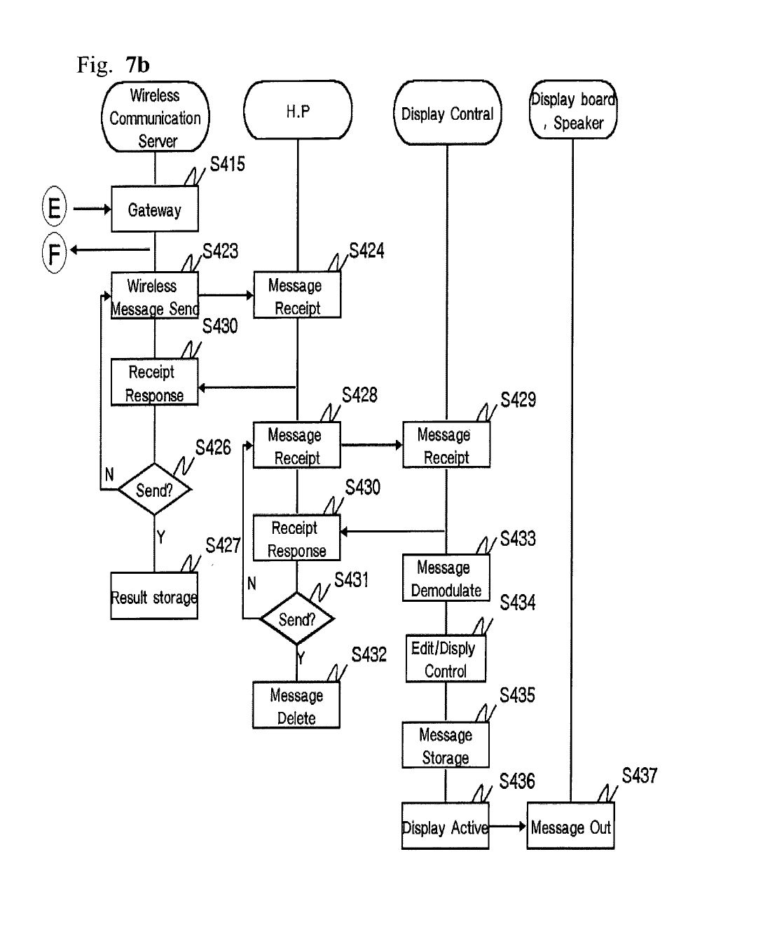

As aforementioned, the invention provides various kinds of supplemental information about stocks, traffic states of expressways or downtown, news, professional baseball, the foreign exchange rate, market statistics of recodes or books, specified industrial conditions, daily bulletins for studying English, or so on, into the output unit 20, by performing the service routines shown in FIG. 7.

Referring to FIG. 7, a main form of a service home page is transferred to the user in response to inputting an address of the web server 41, and the server demands an ID and a password to the user who requests the supplemental information service (S401˜S404). If an input ID and a password have not been registered in the web server, a re-input for the ID and password is required, while a page for the supplemental service is transferred to the user if an input ID and password match with the registered (S405˜S408). Thereafter, during the steps S409˜S413, the supplemental information is supplied to the user by means of the CGI program in accordance with a request for transmission of the supplemental information, and the information is selected in a database when it is regarded to as an internal contents. If the information is external contents, the information is transferred to the wireless communication server, and then passes through the wire/wireless gateways therein (S414, S415). If there is a response of receipt from the CGI program, a transmission result is stored in the database in accordance with an occurrence of the transmission with the information (S416˜S419). No transmission with the information enables a determination process to be performed with messages of success and re-transmission (S420˜S422).

After transferring wireless messages to the H.P. from the communication server, the transmission result is stored in the communication server in response to a response for receipt from the H.P (S423˜S427). And then, the transmitted message is transferred to the output unit 20 through the H.P. terminal, and the message is deleted in the H.P. when the transmission to the output unit is completed (responding to an presence of a response for receipt from the output unit) (S428˜S432). After receiving the message from the H.P., demodulating the message data, editing/controlling the data for displaying, storing the displaying data, and activating the display unit are performed in sequential in order to express the advertising messages on the video part (or a display board) or from the audio part (e.g., a speaker) (S433˜S437).

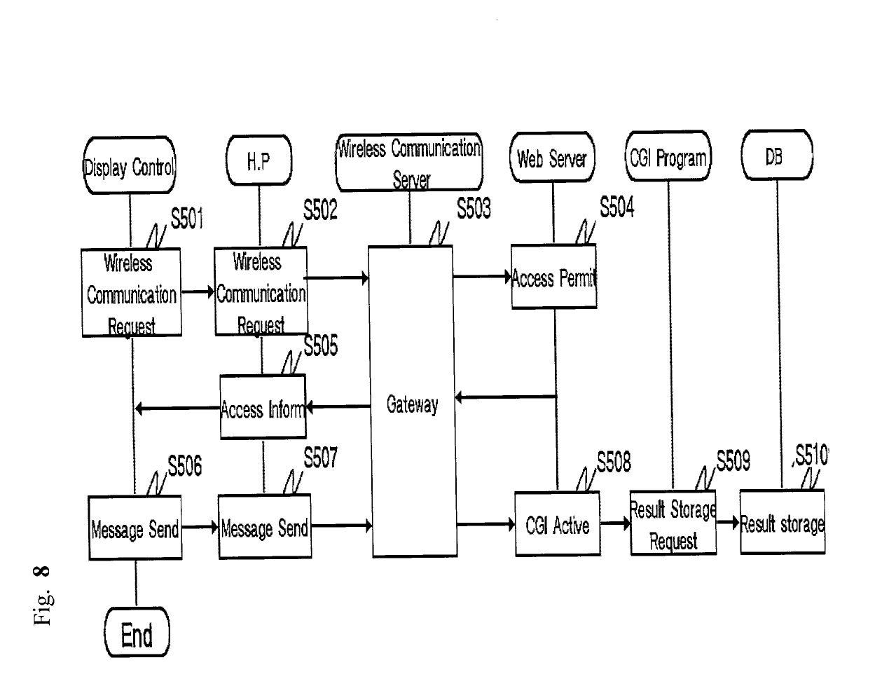

FIG. 8 shows a procedure for performing the transmission operation of the displayed information loaded on the output unit 20 into the advertising information provider 40, corresponding to the steps S400. If a request signal for communicating wireless data is applied to the web server 41 from the H.P. (i.e., hand phone) through the gateways, information of access permission is informed to the output unit from the H.P. (S501˜S505). With conducting the transmission of the messages, if the messages are transferred to the web server 41, a request for storing a transmission result is enabled by activating the CGI program, and thereby the transmission result is stored in the database (S506˜S510).

As described above, various advertising information can be provided to make the user 60 satisfy with them by employing the information provider 40. Furthermore, it is available to send the nearby advertising information thereto, making it possible to modify or to operate the information in a real time. The supplying with the supplemental information enhances the effect of advertisement.

The reverse-transmission of the information loaded on the display unit to the information provider 40 enables to check out current advertising states and to manage them. Such a bi-directional transmission makes the wireless display board system employ the OLAP and data mining process, providing a chance to operate a advertisement planning with a statistical analysis for the information.

With respect to an interfacing with the wireless communication network by connecting the management server 43 with the display system through the internet, which sends messages to the user 60 through wired or wireless terminal, the management server 43 can search user's information on the basis of an user's ID and transfer it thereto. It is available for a communication type employing in the present wireless display board system to be adaptable to one of SMS, WAP, m_HTM, and IMT-2000.

Not even proposed throughout the embodiment of the invention, a receipt of charges for usage and purchase may be done after accounting them. It is also possible to create an vicarious execution for managing a client between the user 60 and the advertising information provider 40, and the charge thereof may be accounted in proportion to the number of clients. The accounting charges in the various ways are handled in the management server 43.

Although the embodied procedure of advertising is composed of transferring the information to the output unit 20, loading the nearby information on the output unit, transferring the information to the information provider 40 from the output unit, and accounting the service charges, in order, the sequential order is variable in accordance with conditional circumstance.

An account would also be added thereon in the case of providing a service between the supplemental and advertising information providers, 50 and 40.

While this invention has been described in connection with what is presently considered to be the most practical and preferred embodiment, it is to be understood that the invention is not limited to the disclosed embodiment, but, on the contrary, is intended to cover various modifications and equivalent arrangements included within the scope of the invention.

What is claimed is:

1. A method for offering advertising information in a wireless display board system, comprising the steps of:
requesting an advertisement service to a wireless advertising information provider through a network by an user;
transmitting the wireless advertising information to an output unit from the advertising information provider in response to the service requesting;
loading nearby advertising information on the output unit by means of an operating device at a place near the output unit; and
transmitting one of the wireless advertising information and the nearby advertising information which are displayed on the output unit into the advertising information provider.

2. The method of claim 1, further comprising the steps of:
transmitting a counted data relevant to a displaying time of the advertising information into the advertising information provider through a mobile communication site; and
accounting a charge for using the advertising information on the basis of the displaying time.

3. The method of claim 2, wherein the step of transmitting the counted data of the displaying time comprises the steps of:
storing the wireless advertising information and the nearby advertising information in a storage unit; and
transmitting the stored advertising information to the advertising information provider through a network.

4. The method of claim 3, wherein the output unit includes at least one of a video part displaying the advertising information in a visual state, and a audio part expressing the advertising information in a audible state.

5. The method of claim 1, wherein the step of transmitting the wireless advertising information comprises:
transmitting the wireless advertising information to a mobile communication site through a wired network; and
transmitting the wireless advertising information to the output unit and displaying the wireless advertising information on the output unit.

6. The method of claim 5, wherein the step of displaying the wireless advertising information comprises the steps of:
receiving the wireless advertising information supplied from a server into a receiver of the output unit; and
storing the wireless advertising information in a storage unit of the output unit and displaying the wireless advertising information on a display unit of the output unit in accordance with a control operation of an output controller of the output unit.

7. The method of claim 6, wherein the receiver is a hand phone.

8. The method of claim 6, wherein the server is adaptable to at least one of SMS, WAP, m_HTM, and IMT-2000.

9. The method of claim 1, wherein the step of transmitting the nearby advertising information comprises the step:
receiving an input data supplied by the operating device into a receiver of the output unit; and
storing the input data in a storage unit of the output unit and displaying the input data on a display unit of the output unit in accordance with a control operation of an output controller of the output unit.

10. The method of claim 9, wherein the operating device is a remote controller by which characters or audio signals are supplied to the receiver.

11. The method of claim 1, wherein the step of requesting the advertisement service comprises the steps of:
writing out an application for requesting the advertising service by an user; and
storing the application in a database; and
checking out a receipt of the application from the advertising information provider.

12. The method of claim 1, further comprising the steps of:
analyzing information relevant to advertising contents and running time by a program after constructing a database in which the advertising information from the output unit is stacked; and
performing OLAP and data mining process including an accounting for a service charge on the basis of the analyzed information.

13. The method of claim 12, further comprising the steps of:
inputting information into the database, the input information being relevant to the advertising service and conditions of a place where the output unit is fixed;
selecting information corresponding to an user's demand in the database; and
transmitting the selected information to the output unit through a wireless communication network and displaying the selected information on the output unit.

14. The method of claim 1, further comprising the step of providing supplemental information to the output unit from a supplemental information provider, the supplemental information provider being connected to the advertising information provider.

15. A wireless display board system comprising:
an output unit for displaying an information including advertising messages; and
an advertising information provider for transmitting the information to the output unit in response to a request for an advertisement service from an user and for receiving the information displayed on the output unit.

16. The wireless display board system of claim 15, further comprising a mobile communication site, being connected to the advertising information provider and the output unit each through a wired communication network and a wireless communication network, for transmitting the information to the output unit from the advertising information provider.

17. The wireless display board system of claim 16, wherein the advertising information provider comprises:
a web server being accessible with a terminal;
a database server for storing information about users, installing places, and wireless display boards;
a management server for operating detail information about advertisement makers, advertisers, advertising messages, and service charges;
a CRM system for analyzing client information to manage clients and purchase inclination; and
a client management server constructed of a UMS to send mails and characters to the clients;
wherein each of the servers is adaptable to SMS, WAP, m_HTM, or IMT-2000.

18. The wireless display board system of claim 16, wherein the output unit comprises:
a receiver for receiving the information provided from the advertising information provider;
a storage unit for storing the information demodulated;
a display unit for expressing the information in one of a visual state and an audible state; and
an output controller for making the information be expressed on the display unit.

19. The wireless display board system of claim 16, further comprising an operating device, e.g., a remote controller, for applying information such as characters and audio signals into the output unit.

20. The wireless display board system of claim 15, further comprising an operating device, e.g., a remote controller, for applying information such as characters and audio signals into the output unit.
